(19) United States
(12) Patent Application Publication
(10) Pub. No.: US 2005/0213425 A1
(43) Pub. Date: Sep. 29, 2005

(54) Micro-mixer/reactor based on arrays of spatially impinging micro-jets

(76) Inventors: Wanjun Wang, Baton Rouge, LA (US); Ren Yang, Baton Rouge, LA (US); John D. Williams, Baton Rouge, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 11/056,446

(22) Filed: Feb. 11, 2005

Related U.S. Application Data
(60) Provisional application No. 60/544,414, filed on Feb. 13, 2004.

(51) Int. Cl. B01F 15/02

(52) U.S. Cl. 366/150.1; 366/182.1; 366/336; 366/340; 366/341

(57) ABSTRACT

An inexpensive device and method of fabricating micromixers able to enhance the mixing efficiency of fluids by inducing diffusion and turbulence mixing within the micromixer, and by increasing the interfacial surface contact between fluids is disclosed. The device is a passive micromixer capable of mixing at least two different fluids (e.g., a DNA sample and a reagent) by creating impinging plumes of fluid using at least two or more arrays of micro-nozzles sized and shaped to cause the plumes to impact each other directly or interfacially. This novel, passive micromixer may be fabricated on a single substrate using a newly developed lithography technology for thick films of SU-8 resist.

This invention pertains to micromixers, particularly a device and method of enhancing the mixing efficiency of fluids by inducing diffusion and turbulence mixing, and by increasing the interfacial surface contact between fluids.

Microelectromechanical systems (MEMS) technology has opened new opportunities in various industries, such as telecommunications (micro-optical components), and biomedical and chemical applications. Micromixers and microreactors are widely used in biological and chemical Microsystems for purposes such as producing emulsions and gas/liquid dispersions by mixing chemicals or inducing chemical reactions. Micromixers constitute a main component of microreactors with three-dimensional microstructures in fixed matrices for chemical reactions.

In a micromixer, at least two fluids are typically divided into spatially separate fluid streams using a network of microchannels. These fluid streams usually emerge and flow into mixing or reaction chambers as jet flows having identical volumetric flow patterns. Jet flows having different fluids are placed adjacent to each other to allow the fluids to flow into the mixing or reaction chambers and mix by diffusion and turbulence. Identical volumetric flows of each fluid are typically introduced into the mixing or reaction chambers through the microchannels because their mixing ratios would otherwise vary spatially within the chambers, resulting in mixing distortion. Microchannel systems should be configured in such a way that all the microchannel branches are subject to identical, low pressure losses because volumetric flow patterns are affected by pressure losses in the microchannels. See, in general, U.S. Pat. No. 23039169.

A high mixing efficiency in microchannel systems (e.g., microchemical and biological systems) is preferred because it increases the reaction speed and sensitivity of the systems, and allows for rapid and complete mixing of samples and reagents of micro-volumes.

Two basic mixing mechanisms include diffusion and convection. If fluids in a micromixer have a high (>2000) Reynolds number, then the fluid flow will be turbulent and will cause convection. Convection mixing produces macroscopic movement of fluids in micromixers, which carries species from one region of the micromixer to another. Convection mixing is therefore very efficient. When two flows with different concentrations of chemicals or species are bought into physical contact, redistribution of the concentrations will occur because the species or chemicals will diffuse into a flow having a lower density of such chemicals or species. The diffusion process can be described by the following equation:
x=\sqrt{2Dt} (1)
where “D” is diffusion; “x” is the distance a particle travels in fluid; and “t” is the time span. The diffusion of various species in water occurs in the order of 1×10⁻⁹ m²/s. For a laminar flow, the time required for species to diffuse 1 mm in water may theoretically take about 500 sec.

Mixing micro-volumes of fluids in microfluidic systems is often quite difficult. In microfluidic systems, fluid flow in microfluidic systems is laminar and has a low (<2000) Reynolds number, and thus diffusion is a dominant mixing mechanism. Various efforts have been made to improve diffusion mixing processes by introducing geometric irregularities in fluidic channels to create localized eddies and turbulences. For example, Vijayendran, et al., “Evaluation of a Three-Dimensional Micromixer in a Surface-Based Biosensor,” Langmuir, vol. 19, pp. 1824-1828 (2003) discloses a three-dimensional design for micromixer consisting of straight and serpentine microchannels. This design enhances diffusion efficiency of at least two fluids by flowing the fluids across each other. However, there are some complications associated with this design. First, the device requires a long flow channel, which increases the time required to mix fluids. Second, the fabrication process is complicated. The design of the serpentine microchannel comprises four mixing segments placed in series. Each mixing segment is formed by stacking two, in-plane, L-shaped, channel sections. Although the adjacent sections of the mixing segments have slightly different dimensions, the orientation of each L-shaped segment is a mirror image of its adjoining neighbor. Each mixing segment guides the sample flow through the L-shaped section, rotates the fluid by 90 degrees, and then flows the fluid through an adjoining L-shaped section. When several mixing segments are linked together, the flow is subjected to a series of bends and turns that twist the fluid through a series of orthogonal planes. The channel geometry of this device was constructed by patterning the geometrical features into two thin layers of polydimethylsiloxane (PDMS), and then stacking these layers on top of one another. One layer contained the L-shaped sections that form the bottom half of the mixer, while the other contained the complementary L-shaped regions that form the upper half of the device.

In the last few years, research has been very active on low-cost, microfabrication techniques for manufacturing SU-8-based microfluidic reactors due to the superior chemical and mechanical properties of SU-8, in addition to its ease of fabrication using X-ray or UV-based LIGA processes. Complex and multilayered structures are generally produced with relative ease using SU-8 and other materials, such as polymethyl methacrylate (PMMA), polycarbonate (PC), and PDMS, which are compatible with standard silicon processing conditions. As compared to other materials currently used to fabricate microreactors, such as PDMS and PMMA, SU-8 appears to be more suitable, especially for fabricating reactors having fluidic channels with large depths (up to 500 μm).

P. Kaemper, et al., “Microfluidic Components for Biological and Chemical Microreactors,” Proceedings of the IEEE Micro Electro Mechanical Systems (MEMS), pp. 338-343 (1997) discloses a device for enhancing the diffusion mixing of fluids by enlarging the interface between fluids using a long (between about 0.5 m to about 2 m) serpentine-shaped flow channel that maximizes the interfaces of the fluids by subdividing, twisting, and distorting the fluids in a LIGA-fabricated micromixer array. However, there are some complications associated with this design. For example, the device requires a long flow channel, which extends the amount of time required for fluid to flow through the mixing channel to complete the mixing process.

N. Schwesinger, et al., “A Modular Microfluid System with an Integrated Micromixer,” Journal of Micromechanics and Microengineering, vol. 6, no. 1, pp. 99-102 (1996) discloses an integrated modular micromixer system that enhances the diffusion mixing of fluids by flowing the fluids in a zig-zag pattern using cross-over flow channels. The fluids flowing through the crossover channels are forced across each other to induce mixing.

M. Koch, et al., “Improved Characterization Technique for Micromixers,” Journal of Micromechanics and Microengineering, vol. 9, pp. 156-158 (1999) discloses a technique for mixing fluids using a diffusion process by dividing fluid flowing from feeding channels into multiple channels and then recombining the fluids.

Other methods of obtaining high mixing efficiency use active disturbance techniques to create turbulence in the microfluidic systems. For example, Z. Yang, et al., “Ultrasonic Micromixer for Microfluidic Systems,” Sensors and Actuators A, vol. 93, pp. 266-272 (2001) discloses a method of stirring a fluid in a micromixer to enhance fluid mixture by actively disturbing the fluid using an ultrasonic actuator that produces an ultrasonic vibration in the fluid. Mixing is induced by ultrasonic vibration, which causes the temperature of the device to increase. The micromixer comprises inlets, outlets and a mixing chamber fabricated from glass encapsulated by anodic bonding of a Si wafer. To prevent ultrasonic radiation from escaping from the mixing chamber, a diaphragm is etched into the Si wafer.

B. Vivek, et al., “Novel Acoustic-wave Micromixer,” Proceedings of the IEEE Micro Mechanical Systems (MEMS), pp. 668-673 (2000) discloses a method of enhancing fluid mixture in a micromixer by actively producing acoustic vibrations that push and pull the fluid using a fluid Fresnel Annular Sector Actuator (FASA), which focuses acoustic waves (generated by annular rings of half wave-band sources made of a piezoelectric thin film and electrodes through constructive wave interference. Mixing is induced by ultrasonic vibration, which causes the temperature of the device to increase. RF power applied between the electrodes in resonance of the piezoelectric film produces strong acoustic waves, which interfere with each other as they propagate to mix fluid in the micromixer.

Ryo M., et al., “A Highly Sensitive and Small Flow-Type Chemical Analysis System With Integrated Absorptiometric Micro-flowcell,” Proceedings of the IEEE Micro Electro Mechanical System (MEMS), pp. 102-107 (1997) discloses a method of enhancing fluid mixture in a micromixer using an array of micro-nozzles on the bottom of a wide shallow channel on a silicon substrate to create molecular diffusion and convection mixing. In one embodiment, a sample fluid is supplied into the channel and a regent flow is converted into micro-plumes by ejecting the regent through the micro-nozzles into the fluid. This process enhances mixing by increasing the amount of contact surfaces between the regent and the fluid using microscopic nozzles in high concentration on the bottom side of wide, shallow channels fabricated on a silicon substrate. To mix a sample liquid, a reagent is ejected through the nozzles and into the sample liquid.

A. Mahajan et al., “Micromixing Effects in a Two-Impinging-Jets Precipitator,” Fluid Mechanics and Transport Phenomena, pp. 1801-1814 (1996) discloses a method of enhancing fluid mixture in a micromixer using two-impinging jets, which cause coplanar flowing liquids to impinge upon each other inside a mixer chamber.

An unfilled need exists for a fast and inexpensive microfabrication technique for fabricating micromixers able to enhance the mixing efficiency of fluids by inducing diffusion and turbulence mixing, and by increasing the interfacial surface contact between fluids.

We have discovered a novel device and method of fabricating micromixers able to enhance the mixing efficiency of fluids by inducing diffusion and turbulence mixing within the micromixer, and by increasing the interfacial surface contact between fluids. The device is a passive micromixer capable of mixing at least two different fluids (e.g., a DNA sample and a reagent) by creating impinging plumes of fluid using at least two or more arrays of micro-nozzles sized and shaped to cause the plumes to impact each other directly or interfacially. The device is capable of low cost batch-production. The device comprises a mixing chamber and at least two large arrays of micro-nozzles having a height of at least 1 mm and a length ranging between about 1 mm and about 5 mm on opposite sides of the mixing chamber. At least two separate fluids supplied from supply chambers are converted into plumes before being ejected into the mixing chamber by routing the fluids through the micro-nozzles, which causes the fluids to mix in the mixing chamber before being withdrawn.

In one embodiment, the micro-nozzles are positioned on opposite ends of the mixing chamber with nozzles oriented in a face-to-face pattern to allow the plumes to impact each other directly as they are ejected into the mixing chamber containing outflow fluid. In a preferred embodiment, opposite nozzles are offset in a three-dimensional configuration to increase interfacial surface contact between the plumes by allowing the plumes to flow between each other. The micromixer can optionally be incorporated into other biochemical, biological, and chemical analysis systems such as a single molecular detection system, a DNA detection device, or a flow cytometer.

This novel, passive micromixer having arrays of spatially-impinged micro-nozzles with horizontal-oriented passages positioned in a single plane may be fabricated on a single substrate using a newly developed lithography technology for thick films of SU-8 resist. Typical dimensions of the micromixer range from a cross-sectional area of 10 μm×10 μm and a length of 100 μm to a cross-sectional area of 30 μm×30 μm and a length of 2000 μm, with a pressure drop ranging between about 5 Pa to about 80 Pa.

### BRIEF DESCRIPTION OF THE FIGURES

FIG. 1A illustrates a top plan view of a mask used to fabricate an array of micro-nozzles in one embodiment of the micromixer.

FIG. 1B illustrates a top plan view of a mask used to fabricate inlet and outlet channels, and sidewalls in one embodiment of the micromixer.

FIG. 2 is a graph illustrating the distance between two neighboring rectangular patterns on the mask shown in FIG. 1A, which was used determined the width of the micro-nozzles in one embodiment of the micromixer.

FIG. 3 is a schematic diagram of one embodiment of the micromixer.

FIG. 4A is schematic diagram of two arrays of micro-nozzles with a face-to-face orientation.

FIG. 4B is schematic diagram of two arrays of micro-nozzles with an offset orientation.

FIG. 4C is cross-section view of the mixing chamber shown in FIG. 4B. (The symbol ⊙ indicates that fluid jets are flowing outward and the symbols \mathring{×} indicates that fluid jets are flowing inward.)

FIG. 5A is a scanning electron photomicrograph of one embodiment of the micromixer.

FIG. 5B is a scanning electron photomicrograph of one embodiment of the micromixer having three-dimensional, offset-oriented micro-nozzles.

FIG. 6 is a schematic diagram showing the fabrication process for one embodiment of the micro-nozzles using tilt exposure.

FIG. 7 is a graph plotting the orientation of the support substrate and UV-light to obtain a 45-degree incident angle inside the SU-8 photoresist when a prism and optical liquid are used to compensate for any light refraction during the fabrication process of one embodiment of the micro-nozzles.

FIG. 8 is a schematic diagram showing the process for fabricating sidewalls for one embodiment of the micromixer.

FIGS. 9A-9C are scanning electron photomicrographs of arrays of micro-nozzles in one embodiment of the micromixer.

FIG. 10A is an optical scanning electron photomicrograph of one embodiment of the micromixer with fluids flowing into the mixing chamber from arrays of face-to-face oriented micro-nozzles.

FIG. 10B is an optical photomicrograph of one embodiment of the micromixer with fluids flowing 1 mm down stream from the arrays of micro-nozzles in FIG. 10A.

FIG. 10C is an optical photomicrograph of one embodiment of the micromixer with fluids flowing 2 mm down stream from the arrays of micro-nozzles in FIG. 10A.

FIG. 11A is an optical photomicrograph of one embodiment of the micromixer with fluids flowing into the mixing chamber from arrays of face-to-face oriented micro-nozzles.

FIG. 11B is an optical photomicrograph of one embodiment of the micromixer with fluids flowing down stream of the arrays of micro-nozzles in FIG. 11A after ⅙ sec.

FIG. 11C is an optical photomicrograph of one embodiment of the micromixer with fluids flowing down stream of the arrays of micro-nozzles in FIG. 11A after ⅓ sec.

FIG. 11D is an optical photomicrograph of one embodiment of the micromixer with fluids flowing down stream of the arrays of micro-nozzles in FIG. 1A after 1 sec.

FIG. 11E is an optical photomicrograph of one embodiment of the micromixer with fluids flowing down stream of the arrays of micro-nozzles in FIG. 11A after ⅔ sec.

FIG. 11F is an optical photomicrograph of one embodiment of the micromixer with fluids flowing down stream of the arrays of micro-nozzles in FIG. 11 after ⅚ sec.

A general purpose of this invention is to provide an apparatus and inexpensive method for rapid production of micromixers having large arrays of micro-nozzles able to produce plumes of fluid that impact either directly or interfacially to enhance the mixing efficiency of micromixers. More specifically, a purpose of this invention is to provide an inexpensive method for rapid fabrication of micromixer structures suitable for diffusion and turbulence mixing and able to be integrated into other biochemical, biological, and chemical analysis systems.

High chemical compatibility between materials used to construct the microfluidic is preferred. The microfluidic should be compatible with various solvents and harsh chemicals such as tetrahydrofyuran, toluene, acetone, acid (e.g, HCl), base (e.g., NaOH) used by commercial chemical manufacturers during synthesis.

A preferred microfluidic patterning material is SU-8 (MicroChem Corporation, Newton, Mass.). SU-8 is preferred because it is suitable for fabricating reactors having fluidic channels with large depths (up to 500 μm), and it has superior chemical and mechanical properties in addition to its ease of fabrication using X-ray or UV-based LIGA. SU-8 has a high glass transition temperature range (between about 150° C. and about 220° C.), a high shear modulus (between about 6.26 MPa and about 7.49 MPa), Young's modulus from 2396-2605 MPa at R.T. and 653-1017 MPa at 150° C., and is highly resistive to a wide variety of chemicals such as HCl, HNO3, H2SO4, or KOH. It is also bio-compatible and can be treated with other types of bio-materials such as parylene. The maximum operation pressure could be as high as 2.1 MPa for this material.

There are several advantages to microfabricating this device using lithography for thick films of SU-8 resist. The number of components can be minimal. Fabrication can be simple and inexpensive. The novel design is three-dimensional, unlike most prior micromixers which are essentially two-dimensional in design. A three-dimensional design with micro-nozzles can better induce high efficiency between fluids by converting streams of fluids into micro-droplets and mists, and injecting the droplets and mists into the mixing chamber in opposite directions and through fluid contained in the mixing chamber to increase interfacial surface contact between the fluids and allow for diffusion and turbulence mixing of the fluids. The novel design allows for the convenient application of polymer as a structural material for use in chemical reactions and analyses. The large arrays of impinged micro-jets help to improve the mixing efficiency by reducing the potential for the formation of lamina flow. The three-dimensional design with multilayer, spatially impinged jet arrays effectively boast eddies and flow turbulences of fluids in the mixing chamber. The novel design also increases the Reynolds number in the mixing chamber and improves the diffusion affects for mixing by increasing the interfacial surface contact between impinging fluids and converting a higher percentage of kinetic energy in microscopic molecular motions.

### EXAMPLE 1

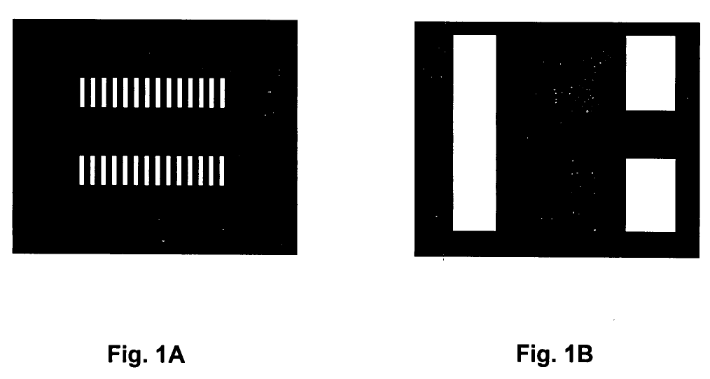

FIGS. 1A and 1B show top plan views of two masks (mask A and mask B, respectively) used to fabricate one embodiment of the micromixer in accordance with this invention. The masks were created using commercially available optical masks manufactured by Nanofilm, Inc. (Westlake Village, Calif.). The masks were constructed from a 1 μm thick layer coated with a positive photoresist (AZ®; Clariant Corporation AZ Electronic Materials, Somerville, N.J.) and an approximately 1 μm thick layer of chrome applied to a piece of soda lime glass or quartz. Two rows having fourteen rectangular slots were printed onto mask A, as shown in FIG. 1A, to form the micro-nozzles, while three rectangular slots were printed onto mask B, as shown in FIG. 1B, to form inlet and outlet channels and sidewalls, using a pattern generator.

The optical masks were then dipped into a 354 or 454 developer solution (Aldrich Chemical Company, Inc., Milwaukee, Wis.) for approximately 1.0-1.5 min and rinsed in deionized water. Because AZ is a positive photoresist, the exposed regions were removed, while the unexposed regions remained after the development process. The optical masks were then dipped into a chrome etching solution (Aldrich Chemical Company, Inc., Milwaukee, Wis.) to pattern a Cr layer. Once the etching process was completed, the optical masks were blow-dried using Nitrogen gas.

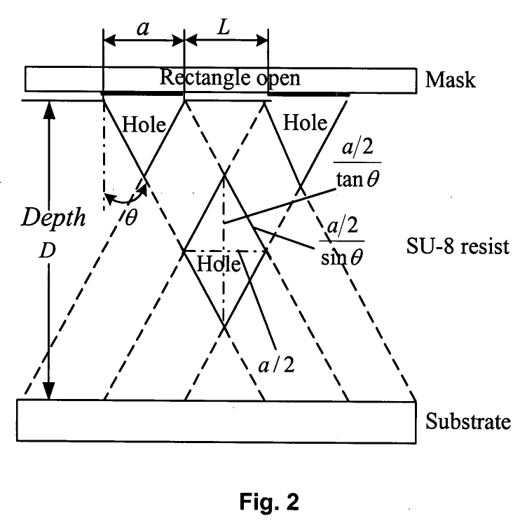

The exposed regions of SU-8 remained, while the unexposed regions of SU-8 were removed after the development process because SU-8 is a negative photoresist. The distance (a) between two neighboring rectangular patterns on the mask A, as shown in FIG. 2, determined the width of the micro-nozzles in the horizontal direction. The width of the micro-nozzles in the horizontal direction can typically be designed from several micrometers to hundreds of micrometers, depending on the working requirements. A variety of shapes can be used to produce micro-nozzles such as diamond, square (with 45 degree incident), or quasi-circle shapes. (The quasi-circle shape is formed by partially over-developing and under-developing the holes). The distance (L) between neighboring holes in the horizontal direction is defined by the length of the rectangular patterns in mask A, which can be designed from several micrometers to hundreds of micrometers as needed. The height of an array of micro-nozzles may be determined measuring the thickness of a coated SU-8 photoresist.

### EXAMPLE 2

The Affects of the Geometric Shapes of the Array of Micro-Nozzles and the Reynolds Number on the Mixing Efficiency of the Micromixer

Calculations were performed to determine the affects of the geometric shapes of the array of micro-nozzles and the Reynolds Number on the mixing efficiency of one embodiment of the micromixer. The number of micro-nozzles was determined by the number of rectangular patterns in Mask A. The cross-sectional area of a diamond-shaped hole for fabricating a micro-nozzle is defined by the following equation:

$$A = \frac{{a}^{2}}{2 tan θ} \qquad ( 2 )$$

where α is the distance between two neighboring rectangular patterns in mask A, and θ is the incident angle of lithography light inside the SU-8 photoresist. The total number of the micro-nozzles may be defined by the depth of the photoresist (D), the distance between two neighbored square opens (a), and the width of the square open (L). The combined affect of geometric shapes of the array of micro-nozzles, diffuse coefficient, and Reynolds number in the mixing chamber determines the mixing efficiency. As shown below, in micromixers having micro-nozzles, the mixing efficiency is only partially affected by the Reynolds number.

The equation for Reynolds number is calculated as following:

$$Re = \frac{ρ Vd}{μ} = \frac{Vd}{γ} \qquad ( 3 )$$

Where ρ is the density of the liquid, μ is the dynamical viscosity, γ is the viscosity, V is the flow velocity, and d is the hydraulic diameter. If the incident angle of the lithography angle is 0 in SU-8 photoresist, from the geometry relationship, as shown in FIG. 1, the hydraulic diameter can be obtained from Eq. (4):

$$d = \frac{4 A}{P} . \qquad ( 4 )$$

in which A is the cross-sectional area, and P is wetted perimeter, the length of wall in contact with the flowing fluid at any cross-section. Assuming the wetted perimeter is the perimeter of the hole, P can be found based on the geometrical relationship as follows:

$$\begin{matrix}P = 4 \cdot ( \frac{a / 2}{sin θ} ) , & ( 5 ) \\ A = 4 \cdot ( \frac{1}{2} \cdot \frac{a}{2} \cdot \frac{a / 2}{tan θ} ) & ( 6 )\end{matrix}$$

Plug Eq. (5) and (6) into (4) to obtain d as shown in Eq. (7):

$$d = \frac{4 A}{P} = a \cdot cos θ \qquad ( 7 )$$

The flow velocity can be obtained as follows:

$$V = \frac{Q}{A \cdot L \# \cdot C \#} \qquad ( 8 )$$

where Q is volume flow rate, A is the cross-sectional area of the holes, L# is the layer number of the pin hole array on the sidewall, and C# is the column number of the pin hole array along the mixing chamber.

$$\begin{matrix}L \# = \frac{( D / cos θ )}{( L / sin θ )} , & ( 9 ) \\ C \# = \frac{2 W}{L} , & ( 10 )\end{matrix}$$

where D is the depth of the mixing chamber, L is the distance between two neighbored holes in horizontal level, and W is the mixing chamber width. L is twice the offset of the hole arrays between face to face oriented nozzles. D can be found in the Eq. (8):
L=ba (11)
Combining Eqs. (9), (10), and (11) and plugging them into Eq. (8), the following equation can be obtained:

$$V = \frac{{Qb}^{2}}{DW} \qquad ( 12 )$$

Combine Eqs. (3) to (8), the Reynolds number in the jet hole of the micromixer can be obtained in Eq. (9) as follows:

$$Re = \frac{Q \cdot {b}^{2} \cdot a \cdot cos θ}{γ \cdot W \cdot L} \qquad ( 13 )$$

From Eq. (13), the maximum Reynolds number in the jet hole can be obtained when θ=0 (physically, it means vertical exposure of the SU-8, not tilted exposure) as shown in Eq. (14).

$${Re}_{max} = \frac{{Qb}^{2} a}{γ WD} \qquad ( 14 )$$

From this result, it can be seen that final mixing result is not dominated by the Reynolds number of the liquid in the jet holes.

### EXAMPLE 3

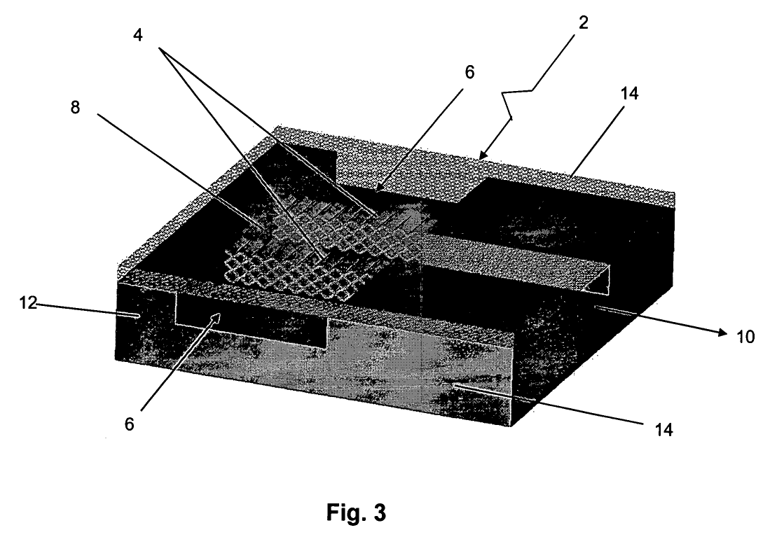

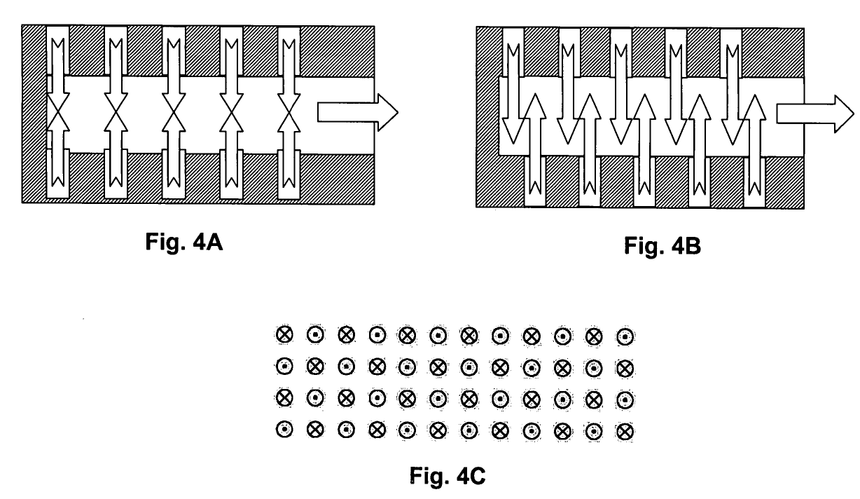

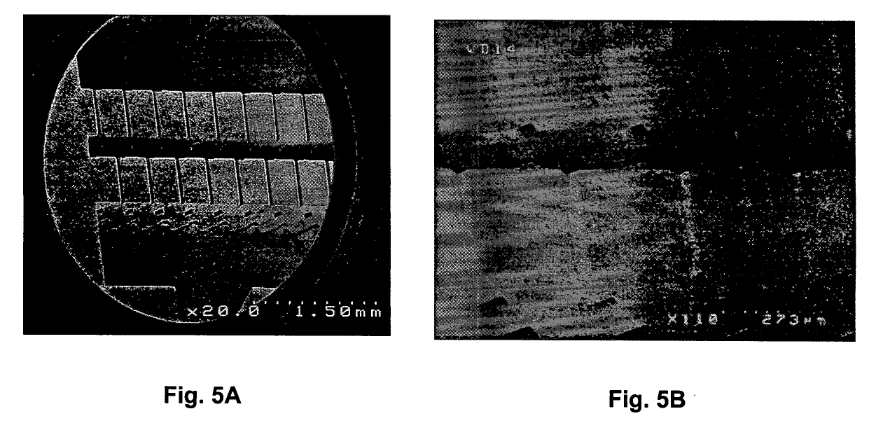

FIG. 3 shows a schematic diagram of one embodiment of a polymeric microfluidic mixer 2, comprising two arrays of impinging micro-nozzles 4, two inlet orifices 6, a mixing chamber 8, and an outlet orifice 10 for outflowing products, prepared using a lithography process for thick films of SU-8 photoresist 12 as more fully explained in Example 4. Micro-nozzles 4 were fabricated in a plane parallel to a 4 in wide silicon support substrate 14. (A variety of other materials may be used as a support substrate such as silicon, glass wafer, polypropylene, polyvinyl chloride, polycarbonate, polyethylene, steel, copper, and nickel.) The arrays of impinging micro-nozzles 4 had a face-to-face orientation (i.e., the micro-nozzles in one array were directly across from the micro-nozzles in the other array). See FIG. 4A. In a preferred embodiment, the arrays of impinging micro-nozzles 4 are offset such that the micro-nozzles 4 in one array are directly across from the spacing between micro-nozzles 4 in the other array to allow for the generation of additional fluid vortices in the mixing chamber 8 by flowing fluid exiting one array of micro-nozzles 4 across the mixing chamber 8 towards the other array of micro-nozzles 4, which increases the interfacial contact between the fluids exiting the micro-nozzles 4. See FIGS. 4B, 4C, and 5B. The microfluidic mixer 2 had square-shaped micro-nozzles 4 with dimensions of approximately 70 μm×70 μm×210 μm width, height, and distance between adjacent micro-nozzles, respectively). In an alternative embodiment, the microfluidic mixer may have micro-nozzles with a variety of shapes (e.g., diamonds, ovals and rectangles) with cross-sectional areas ranging from between 10 μm and about 1 mm². Inlet orifices 6 had a width of 1 mm, a length of 4 mm and a height of 1 mm. The dimensions of mixing chamber 8 were 1000 μm×1000 μm×5000 μm (width, depth, and length, respectively). In this embodiment, the micro-nozzles 4 were sized and shaped to aid in the mixing process of two fluids by converting the fluids flowed through inlet orifices 6 into plumes of streams able to pass through any surrounding outflow fluids contained in the mixing chamber 8 before impinging upon each other. The arrays of impinging micro-nozzles 4 had a three-dimensional design, which helped to increase the mixing rate of fluids by increasing the number of fluid vortexes formed in the mixing chamber 8. At steady state conditions, both of the fluids were continuously supplied to the mixing chamber 8 at a constant rate. The resultant plumes of fluid from one particular pair of micro-nozzles 4 passed through the plumes of streams from neighboring pairs of micro-nozzles 4 before the resultant fluid exited the mixing chamber 8.

This mixing process can be better understood from the following theoretical analysis based on a fundamental study presented in A. Mahajan, et al., “Micromixing Effects in a Two-Impinging-Jets Precipitator,” Fluid Mechanics and Transport Phenomena, Vol. 42, No. 7, pp. 1801-1814 (1996), discloses that the time constant, Tₘ, for a micromixing process may be defined as a function of diffusion D of a fluid and Kolmogoroff length, λ,
Tₘ=(0.5λ)²/D (15)
where λ is expressed as,
λ=[ρVν³/P]^{-1/4} (16)
and where ρ is the mass density of the fluid, P is the energy dissipation rate, V is the volume of fluid within which energy is dissipated, and ν is kinetic viscosity of the fluid. P and V may only be estimated for a specific micromixer design having specified dimensions and shapes.

The above-described analysis may be simplified by assuming that the kinetic energy is completely dissipated into the mixed solution when two microfluidic nozzles, fluid nozzle 1 and fluid nozzle 2, impinge upon each other and the velocity is reduced to zero. The energy dissipation, P, of the fluids may then be calculated as follows:

$$P = \frac{π}{8} \frac{{Re}_{1}^{3} {ρ}_{1} {v}_{1}^{3}}{{d}_{1}} ( 1 + \frac{{m}_{1}}{{m}_{2}} ) , \qquad ( 17 )$$

where m₁ and m₂ are the mass of at least two fluids, fluid 1 and fluid 2; Re₁ is the Reynolds number for fluid 1, and d₁ is the diameter of fluid nozzle 1.

If the physical properties (ρ and ν) of the two microfluidic nozzles are assumed to be equal, the relationship for a time constant may be simplified by plugging Eqs. (17) and (16) into Eq. (15) to obtain the following proportionality:

$${T}_{m} ∝ \frac{{d}_{1}^{0.5} {V}^{0.5}}{{{Re}_{1}^{1.5} ( 1 + {m}_{1} / {m}_{2} )}^{0.5}} . \qquad ( 18 )$$

From Eq. (5), it may be shown that to obtain a smaller mixing time constant (i.e., a faster mixing rate), several variations in mixer design may be used, including designs that increase mixing efficiency by increasing the Reynolds number of fluid flowing through the mixer, designs that reduce the diameter of micro-jets, and designs that reduce the jet flow volume (i.e., the total volume of fluid being mixed).

### EXAMPLE 4

Fabrication of the Micromixer/Reactor

FIGS. 5A and 5B are scanning electron photomicrographs of one embodiment of arrays of micro-nozzles fabricated using a UV lithography of SU-8, in accordance with this invention. (Other exposure sources may also be used to expose SU-8 such as electron-beam and x-rays.) In this embodiment, arrays of micro-nozzles were created using an unconventional lithography of SU-8 100 photoresist. Other thick negative photoresists materials may be used to fabricate the micromixer such as SU-8 50 or SU-8 75. First, a silicon substrate was cleaned with acetone, isopropyl alcohol and deionized water, and then dried in an oven at 150° C. for a half hour. To obtain a layer of SU-8 with a thickness of approximately 1100 μm, SU-8 100 photoresist was spin-coated onto the substrate at a speed of 400 rpm for approximately 25 seconds. Afterwards, the substrate was placed onto a hot-plate and baked at 110° C. for 10 hours. The substrate was then allowed to cool to room temperature over a period of approximately 8-9 hours. Glycerin was applied to the central region of the substrate, and then mask A was placed over the SU-8 photoresist layer to minimize the potential for errors caused by diffraction between the mask and the SU-8 layer. (Mask A and the silicon substrate were held together using a specially-designed chuck that allowed the mask and substrate to be rotated to obtain incident angles of (+) 45 degrees and (−) 45 degrees inside the SU-8 photoresist.)

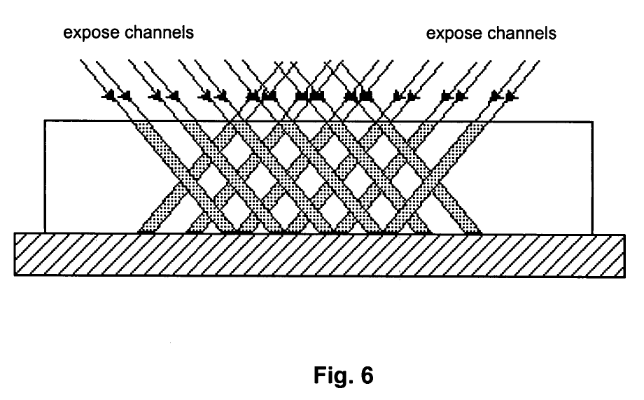

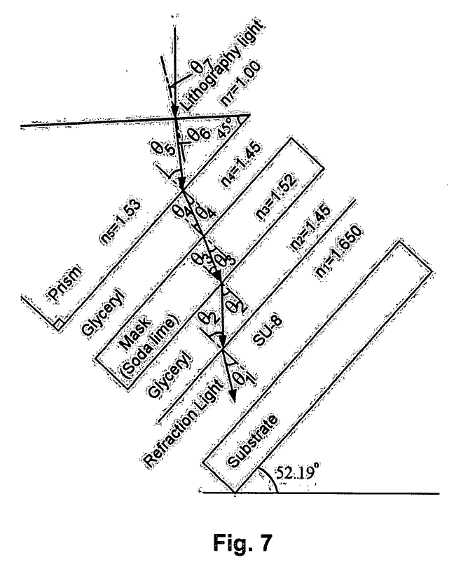

Using a tilted lithography process, as shown schematically in FIG. 6, the photoresist was exposed to two arrays of narrowly-stripped UV-light beams (320-450 nm, Oriel UV station, Model # 85110; Oriel Corporation, Stratford, Conn.) to pattern the sidewalls of the horizontally-oriented arrays of micro-nozzles. The UV-light required to pattern the micro-nozzles varied from about 1680 mJ/cm² for a 500 μm thick, soft-baked SU-8 to about 2880 mJ/cm² for a 1000 μm thick, soft-baked SU-8. To compensate for light progation at the surface of the SU-8 photoresist, horizontally-oriented arrays of micro-nozzles were produced based on the refraction index of SU-8 photoresist (n=1.668 at λ=365 nm, n=1.650 at λ=405 nm) by exposing the photoresist to UV-light at an angle of about 45 degrees as shown in FIG. 7. (If the microsized flow channel design requires 90-degree intersections, a coupling prism and optical liquid may be used to compensate for light refraction to obtain square, cross-sectional flow channels.)

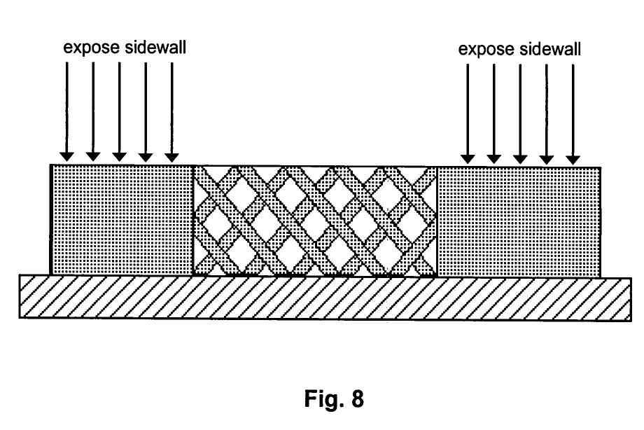

Once the tilted lithography procedure was completed, mask A was released from the photoresist by dipping the mask and the photoresist into deionized water. Mask B was then used to fabricate inlet and outlet channels and flow channel sidewalls in the photoresist, and to ensure that the arrays of micro-nozzles were correctly aligned with the sidewalls by exposing the photoresist to UV-light (320-450 nm, Oriel UV station, Model # 85110; Oriel Corporation, Stratford, Conn.) in an aligned orientation as shown in FIG. 8. The exposed SU-8 photoresist was then placed on a hot-plate for post-baking at a temperature of 96° C. for 20 min, and allowed to cool to room temperature over a period of approximately 8-9 hr to release any residual stress in the photoresist. Afterwards, the photoresist was developed using an SU-8 developer solution. The SU-8 developer was a proprietary solution distributed by the MicroChem Corporation (MicroChem Corporation, Newton, Mass.). The photoresist was developed in a 250 W megasonic agitator having a megasonic transducer (SONOSYS Ultraschallsysteme GmbH, Neuenbuerg, Germany). The megasonic agitator was used to enhance the development process by removing unexposed regions from the photoresist, which formed the horizontal-oriented arrays of impinging micro-nozzles. The megasonic transducer was placed in a water bath supporting a quartz tank in which the developer and substrate were located. The silicon wafer was then placed into the quartz tank and positioned perpendicular to output of the transducer to create the micro-nozzle channels along the direction of the propagation of megasonic waves output by the transducer. See Ren Yang et al., “Fabrication of Out-of-Plane SU-8 Refractive Microlens Using Directly Lithography Method,” Proceedings of SPIE—The International Society for Optical Engineering, Vol. 5346, pp. 151-159 (2004).

Once development of the photoresist was completed and the unexposed areas of the photoresist were removed to form microholes, the photoresist was rinsed in isopropyl alcohol for 10 min, and then in deionized water for an additional 10 min, before drying the photoresist with nitrogen. A top cover was then fabricated from a 10 mm×10 mm×1 mm (width, length, thickness, respectively) piece of silicon glass. See FIG. 5A. Other materials such as polymer or silicon may be used to fabricate the top cover. An approximately 5-10 μm thin layer of SU-8 was spin coated onto the top cover, and then the top cover was placed onto a hot-plate and soft-baked at 96° C. for 5 min. The top cover was then allowed to cool. The top cover was then bonded onto the bottom portion of the micromixer, as shown in FIG. 5A, by applying an approximately 100 g load onto the top cover and soft-baking the device at 96° C. for 5 min, before allowing the device to cool to room temperature. The SU-8 photoresist was then cured by flood exposure at about 300 mJ/cm² to form a bonded micromixer. The bonded micromixer was then post-baked at 100° C. for 10 min and allowed to cool down to room temperature. Alternatively, the top cover may be bonded to the base of the micromixer by spin-coating a thin layer (˜1-5 μm) epoxy glue onto the cover glass and pressing the cover glass onto the base of using an approximately 500 g load for 5 hours to complete the bonding process.

### EXAMPLE 5

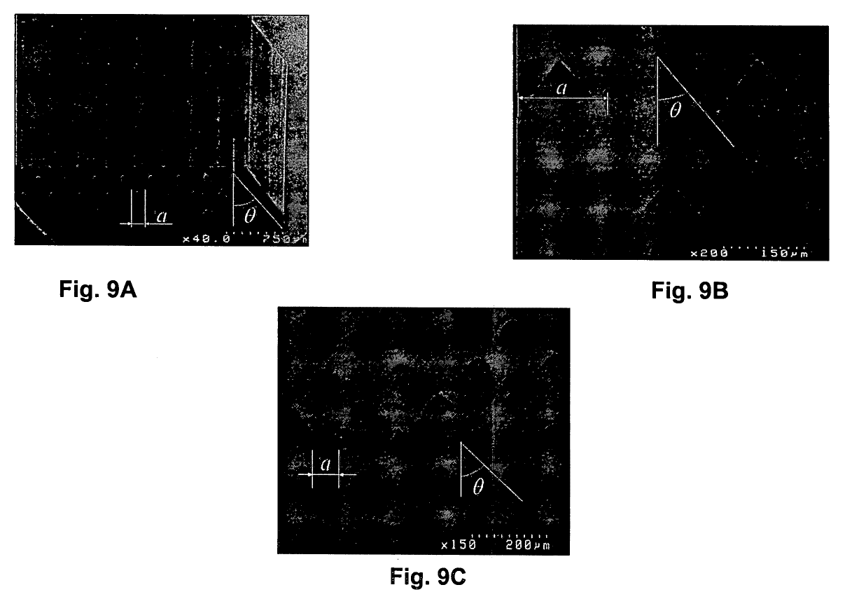

FIGS. 9A-9C show other micro-nozzles fabricated using the method described in Example 4. The angles and the diagonal lengths of the micro-nozzles were measured using a Nikon MM-22U microscope (Nikon, Tokyo Japan). The micro-nozzles, as shown in FIG. 9A, were 125 μm wide, 2000 μm long, and had a light incident angle, θ, of 28.1 degrees and a horizontal diagonal, a, of 87.4 μm. FIG. 9B shows a close-up view of micro-nozzles having a width of 75 μm and a length of 2000 μm. As shown in FIG. 9B, the micro-nozzles had a light incident angle of 30.9 degrees and a horizontal diagonal of 153.2 μm. The micro-nozzles, as shown in FIG. 9C, had a width of approximately 30 μm, a length of 2000 μm, and had a light incident angle of θ=45.1° and a horizontal diagonal of 45.6 μm.

### EXAMPLE 6

To demonstrate the effectiveness of the micromixer, comparison tests were performed with the prototype micromixer having face-to face and offset-oriented arrays of spatially impinging micro-nozzles as described in Example 3. The mixing chamber had a depth of 1000 μm and a width (i.e., the distance between the arrays) of 5000 μm. The micro-nozzles had a 70 μm×70 μm×300 μm (width, depth, length, respectively), diamond-shaped cross-sectional area. The flow rate used in these experiments was 20 μL/min. The distance between the two arrays of nozzles was 210 μm.

Two plastic syringes (BD, Inc., Franklin Lakes, N.J.) were seated on a syringe pump. One syringe contained deionized water and the other contained a 1.2 mMol/L fluoresce dye solution (Catalog # F245-6; Aldrich Chemical Company, Inc., Milwaukee, Wis.). A syringe pump (Harvard Apparatus' PicoPlus, Holliston, Mass.) was used to control the flow rate of the syringes and to allow for the flow rate at the left inlet to equal that of the right inlet. The fluoresce dye solution and the DI water were pumped through the arrays of the micro-nozzles and were mixed in the mixing chamber. The mixed solution flowed out the outlet channel. A mercury lamp was then used to project illumination light through the microscope onto the mixing chamber. The illumination light and the reflected light from the mixing chamber were filtered to allow the illumination light to pass through using an optical filter (Edmund Industrial Optics, Barrington, N.J.). Images of mixing fluid flow were then magnified with a microscope and a digital video camera capable of videoing approximately 30 frames per second with two fields per frame such as a Nikon CV-252 camera (Nikon, Tokyo, Japan) was used to monitor the mixing process.

The mixing efficiency was determined by examining the gray-scale distribution in the photo images of the video camera. Regions of the mixing flow having high concentrations of fluoresce dye were brighter than those with lower concentrations of fluoresce dye. (Because the video camera used in these experiments had a limited depth of focus, the images of the mixing process depict a thin layer of liquid flowing into the mixing chamber from only one layer of micro-nozzles.)

Micromixer having Face-To-Face Oriented Micro-Nozzles

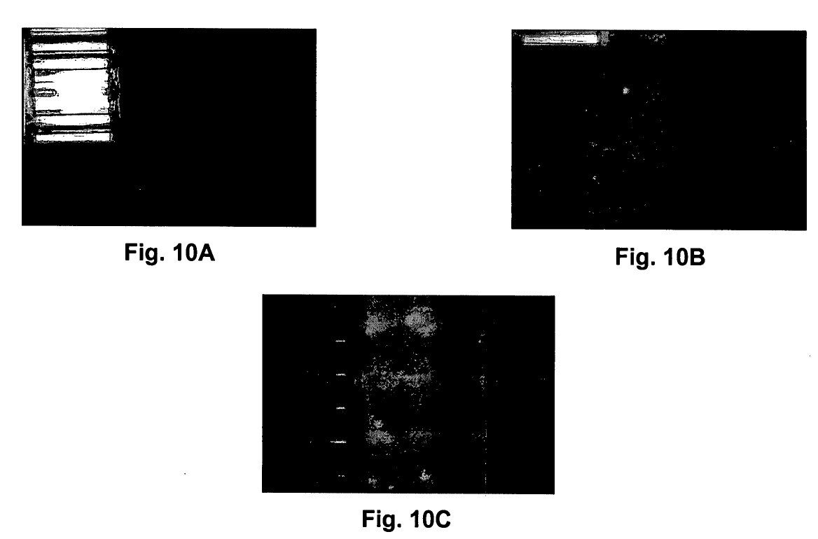

FIGS. 10A-10C show one embodiment of the micromixer with fluids flowing into the mixing chamber from arrays of face-to-face oriented micro-nozzles. See FIG. 4A. The fluoresce dye solution and deionized water impinged each other face-to-face, and appeared to form a boundary region in the center of the mixing chamber as shown in FIG. 10A. Images of the fluoresce dye solution and deionized water at positions 1 mm and 2 mm downstream of the outlets of each array of micro-nozzles indicate that the micromixer effectively mixed the solution and water within a short distance downstream of the micro-nozzles, along the outlet channel, as shown in FIGS. 10B and 10C, respectively.

Micromixer having Offset-Oriented Micro-Nozzles

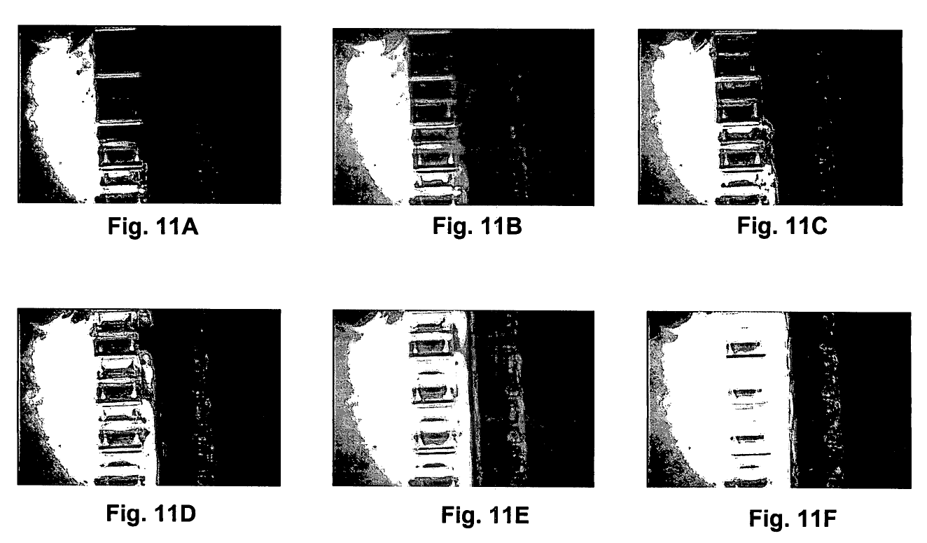

FIGS. 11A-11F show one embodiment of the micromixer with fluids flowing into the mixing chamber from arrays of offset oriented micro-nozzles. See FIG. 4B. Fluoresce dye solution and deionized water were pumped into the mixing chamber in opposite directions. Images of the fluoresce dye solution and the deionized water show the mixing process was completed inside the mixing chamber in less than one second.

### EXAMPLE 7

To further understand the effectiveness of the prototype micromixer, the Reynolds number for fluid in the micro-nozzles shown in FIGS. 10 and 11 was estimated. (If the incident angle of the lithography angle is θ in SU-8 photoresist, the micro-nozzles cannot be fabricated with a non-square cross-section as a function of the angle θ. See FIG. 9B. Assuming a is the diagonal of the micro-nozzle in the plane of the substrate as shown in FIG. 9B, V is the flow velocity, and d is the hydraulic diameter, Q is volume flow rate, A is the cross-sectional area of the micro-nozzles, N is the number of the nozzles, the equation for Reynolds number is as follows:

$$Re = \frac{ρ Vd}{μ} = \frac{ρ Q \cdot a \cdot cos θ}{μ \cdot A \cdot N} , \qquad ( 19 )$$

where ρ is the density of the liquid, μ is the dynamical viscosity. It was assumed that the flow was sufficient to completely fill the micro-nozzles. Eq. 19 shows the relationship between the number of micro-nozzles and their cross-sectional area.

The structures used for the experiments shown in FIGS. 10A-10C had a lithography angle, θ, inside the SU-8 photoresist of approximately 28. At an input flow rate of 20 μL/min, the micro-nozzles had a flow velocity of approximately 0.00167 m/s and a Reynolds number of approximately 0.0002 at the entrances of the micro-nozzles and approximately 0.1456 at the exit of the micro-nozzles.

The experimental results show that the micromixer, both with face-to-face and offset-oriented micro-nozzles, achieved rapid mixing. The micromixer based on arrays of offset-oriented micro-nozzles appears to have a higher mixing efficiency than the micromixer with face-to-face oriented micro-nozzles. The micromixer with a narrower mixing chamber (i.e., a shorter space between facing micro-nozzles) provided a higher mixing efficiency. Without wishing to be bound by this theory, it is believed that this was caused by the increased ability of the offset-oriented micro-nozzles to eject fluid to the opposite side of the mixing chamber, which caused an increase level of interfacial contact between the fluids being ejected from both arrays of micro-nozzles. Finally, the use of a large number of micro-nozzles boasted the mixing efficiency.

The complete disclosures of all references cited in this specification are hereby incorporated by reference. Also incorporated by reference is the following publication of the inventors' own work: R. Yang et al., “A rapid Micromixer/Reactor Based on Arrays of Spatially Impinging Micro-Jets,” Journal of Micromechanics and Microengineering, Vol. 14, No. 10, pp. 1345-1351 (2004); and R. Yang et al., “Fabrication of Out-of-Plane SU-8 Refractive Microlens Using Directly Lithography Method,” Proceedings of SPIE—The International Society for Optical Engineering, Vol. 5346, pp. 151-159 (2004). In the event of an otherwise irreconcilable conflict, however, the present specification shall control.

1. A device comprising a plurality of walls; and at least two fluid inlets, a first inlet adapted to supply a first fluid and a second inlet adapted to supply a second fluid; wherein:
(a) said walls form a generally enclosed chamber having at least one outlet;
(b) at least two of said walls are porous, a first porous wall and a second porous wall;
(c) each said porous wall contains a plurality of channels; wherein each channel has a first opening on one side of said porous wall and a second opening on another side of said porous wall; such that each channel is adapted to allow streams of fluid to flow into the channel's first opening, to flow through the porous wall, and to exit from the channel's second opening into the generally enclosed chamber;
(d) the first openings of the channels of said first porous wall are in fluid communication with said first inlet, and the first openings of the channels of said second porous wall are in fluid communication with said second inlet; whereby a first fluid supplied by said first inlet may flow through the channels of said first porous wall into the generally enclosed chamber, and a second fluid supplied by said second inlet may flow through the channels of said second porous wall into the generally enclosed chamber; and wherein said channels have a cross-sectional area ranging between about 10 μm² and about 1 mm²;
(e) the positions of the second openings of said first porous wall and the positions of the second openings of said second porous wall, relative to one another, are adapted to mix the first and second fluids within the generally enclosed chamber before the mixed fluids exit the chamber through the at least one outlet.

2. An apparatus as recited in claim 1, wherein said walls and said plurality of channels comprise SU-8.

3. An apparatus as recited in claim 1, wherein said plurality of channels are fabricated by exposing each said porous wall to two or more beams of radiation at an angle of exposure of ranging from between about 0 degrees to about 90 degrees.

4. An apparatus as recited in claim 3, wherein the beams of radiation are supplied by radiation-generating devices selected from the group consisting of ultraviolet light, x-ray, and electron-beam generating devices.

5. An apparatus as recited in claim 1, wherein said plurality of channels are fabricated by exposing each said porous wall to two or more beams of radiation at an angle of exposure of about 45 degrees.

6. An apparatus as recited in claim 1, wherein said channels of said first porous wall and said channels of said second porous wall are adapted to convert said first and second fluids into plumes of fluids.

7. An apparatus as recited in claim 6, wherein said positions of said second openings of said first porous wall and said positions of said second openings of said second porous wall are adapted to cause said first and second fluids to impact each other directly.

8. An apparatus as recited in claim 6, wherein said positions of said second openings of said first porous wall and said positions of said second openings of said second porous wall are adapted to cause said first and second fluids to increase the interfacial contact between said first and second fluids by allowing said first and second fluids to flow between each other.

9. An apparatus as recited in claim 1, wherein said device is adapted to be fluidically-connected to external components selected from the group consisting of fluidic devices, reservoirs, pumps, and inlets for fluids.

10. An apparatus as recited in claim 1, wherein said device is a completely polymeric micromixer.

11. An apparatus as recited in claim 1, wherein said channels have a cross-sectional shape selected from the group consisting of diamonds, squares, ovals, and rectangles.
